(19) United States
(12) Patent Application Publication
(10) Pub. No.: US 2010/0318854 A1
(43) Pub. Date: Dec. 16, 2010

(54) SYSTEM AND METHOD FOR CHECKING FIRMWARE DEFINITION FILE

(75) Inventor: Chung-Nan CHEN, Taipei City (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/761,414

(22) Filed: Apr. 16, 2010

(30) Foreign Application Priority Data
Jun. 15, 2009 (TW) 98119970

(51) Int. Cl. G06F 11/36

(52) U.S. Cl. 714/38; 714/E11.207

(57) ABSTRACT

A system and a method for checking a firmware definition file are provided. The system includes a software control side and a plurality of hardware signal sides. The software control side has a firmware definition file, and generates a plurality of simulating signals in accordance with the firmware definition file. The hardware signal sides receive the simulating signals respectively so as to generate a plurality of feedback signals fed to the software control side. The software control side establishes an event log in accordance with the feedback signals, and uses the event log to check if the firmware definition file is correct.

### RELATED APPLICATIONS

This application claims priority to Taiwan Application Serial Number 98119970, filed Jun. 15, 2009, which is herein incorporated by reference.

### BACKGROUND

1. Field of Invention

The present invention relates to a firmware definition file. More particularly, the present invention relates to a system and a method for checking the firmware definition file.

2. Description of Related Art

There generally exists an event log mechanism in server management software nowadays, and the server management software uses the event log mechanism to inform a user of a status of current hardware equipment. Hence, whether the event log mechanism can correctly reflect the status of the hardware equipment depends on the correctness of a firmware definition file in the management software.

When a system is under development, it is quite a common problem that signal patterns defined in the firmware definition file fail to reflect an actual status of hardware equipment. At this moment, system developers are relied on to debug the errors one by one. However, the debugging process often is conducted merely against the problems appearing in burn-in tests or accidentally found by the system developers. Let's say that the occurrence of a first situation leading to the occurrence of a second situation is defined in the firmware definition file as a first event so as to reflect the first situation; and only the second situation occurring is defined in the firmware definition file as a second event so as to reflect the second situation. In this case, it is difficult to check whether the second situation is linked to the second event correctly. For example, assume that the first situation is defined as true when the temperature of a system is greater than 80 degrees C., and the second situation is defined as true when the temperature of the system is greater than 60 degrees C. Then, when the first situation is true, the second situation is definitely true. While being at a common burn-in test, the system is generally set to be operated under the worst case so as to check various responses of the system, so that it is very easy to neglect the case of only the second situation occurring (without the first situation occurring, such as the temperature between 60 degrees C. and 80 degrees C.). In other words, the checking method based on the firmware definition file is not strict.

### SUMMARY

Hence, an aspect of the present invention is to provide a system for checking a firmware definition file so as to strictly confirm a defined number of events and a defined content of event listed in the firmware definition file.

According to an embodiment, the system for checking the firmware definition file includes a software control side and a plurality of hardware signal sides. The software control side has the firmware definition file, and generates a plurality of simulating signals in accordance with the firmware definition file. The hardware signal sides receive the simulating signals respectively so as to generate a plurality of feedback signals fed to the software control side, wherein the software control side establishes an event log in accordance with the feedback signals, and uses the event log to check if the entire firmware definition file is correct.

Another aspect of the present invention is to provide a method for checking the firmware definition file so as to check if various events defined in the firmware definition file can be reflected realistically.

According to an embodiment, the method for checking the firmware definition file includes the following steps. The firmware definition file is read from a software control side, and a plurality of simulating signals are generated in accordance with the firmware definition file. A plurality of connection ports are actually detected by the software control side, wherein the connection ports are corresponding to a plurality of hardware signal sides. The simulating signals are sent to the hardware signal sides from the software control side via the connection ports. A plurality of feedback signals are obtained from the hardware signal sides, and an event log is established by using the feedback signals. The event log is compared with the feedback signals for checking if the firmware definition file is correct. Accordingly, the method for checking the firmware definition file can reflect all of the events anticipated in the firmware definition file to the event log, thereby checking if the firmware definition file is correct by comparing the event log with the firmware definition file.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram showing a system for checking a firmware definition file according to an embodiment of the present invention;

FIG. 2 is a flow chart showing a method for checking a firmware definition file according to an embodiment of the present invention; and

FIG. 3(a) and FIG. 3(b) are a flow chart showing the detailed steps of FIG. 2.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

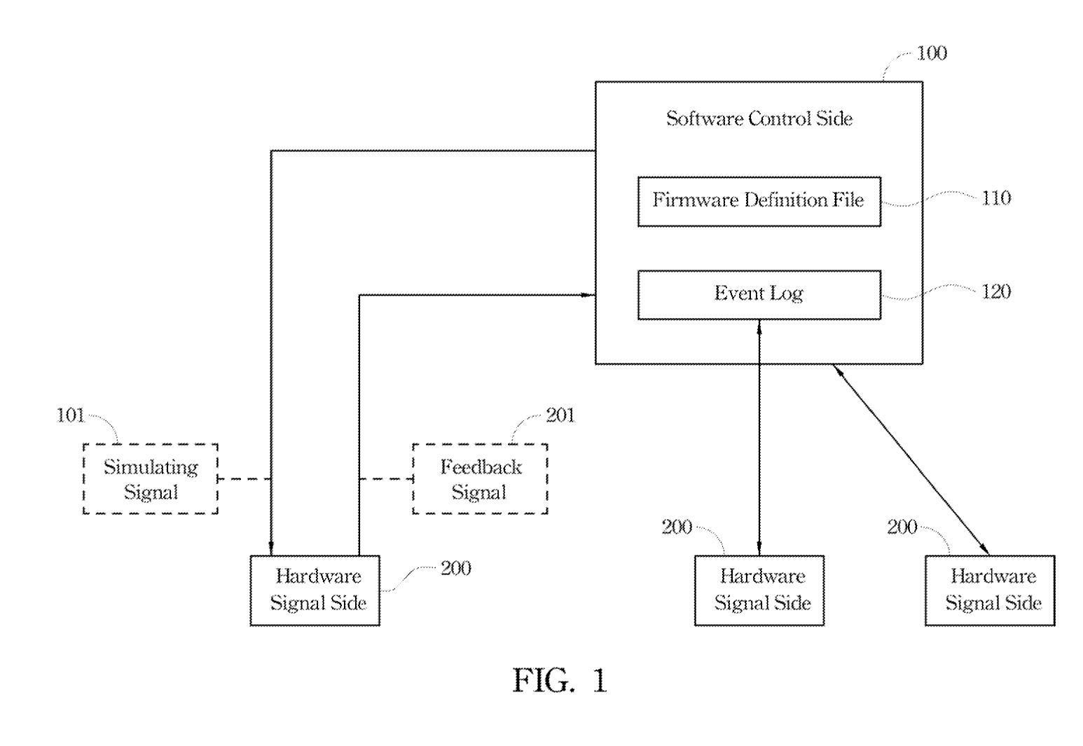

Referring to FIG. 1, FIG. 1 is a schematic diagram showing a system for checking a firmware definition file according to an embodiment of the present invention. In FIG. 1, the system of this embodiment includes a software control side 100 and a plurality of hardware signal sides 200. The software control side 100 has the firmware definition file 110, and generates a plurality of simulating signals 101 in accordance with the firmware definition file 110. Concretely speaking, the hardware signal sides 200 can be a plurality of hardware components with feedback functions in a server system, such as a temperature sensor, a fan speed sensor, a clock sensor of an operation chip such as a central processing unit, and various types of voltage and current sensors.

The hardware signal sides 200 receive the simulating signals 101 respectively so as to generate a plurality of feedback signals 201 fed to the software control side 100. A temperature sensor is used herein as an example for explanation. A normal temperature sensor may reply three types of sensor signals regarding a normal temperature, an over-high temperature and an extremely-high temperature. To check if the firmware definition file is correct, the software control side 100 may send out three simulating signals 101 representing the aforementioned three temperatures sequentially, and then the hardware signal sides 200 may issue three feedback signals 201 corresponding thereto, thereby responding to these three different temperatures.

Thereafter, the software control side 100 may establish an event log 120 in accordance with these feedback signals 291, and uses the event log 120 to check if the firmware definition file 110 is correct, for example, to check if each of the aforementioned three temperatures can be reflected, and if the response content matches with the expected result.

In other words, in this embodiment, the system for checking the firmware definition file can read out the definitions of various events listed in the firmware definition file 110 automatically, and send out the event-simulating signals to the hardware signal sides 200, and then obtains the feedback results from the hardware signal sides 200, and thereafter compares the feedback results with the simulated events to check if their event numbers and contents are mutually matched.

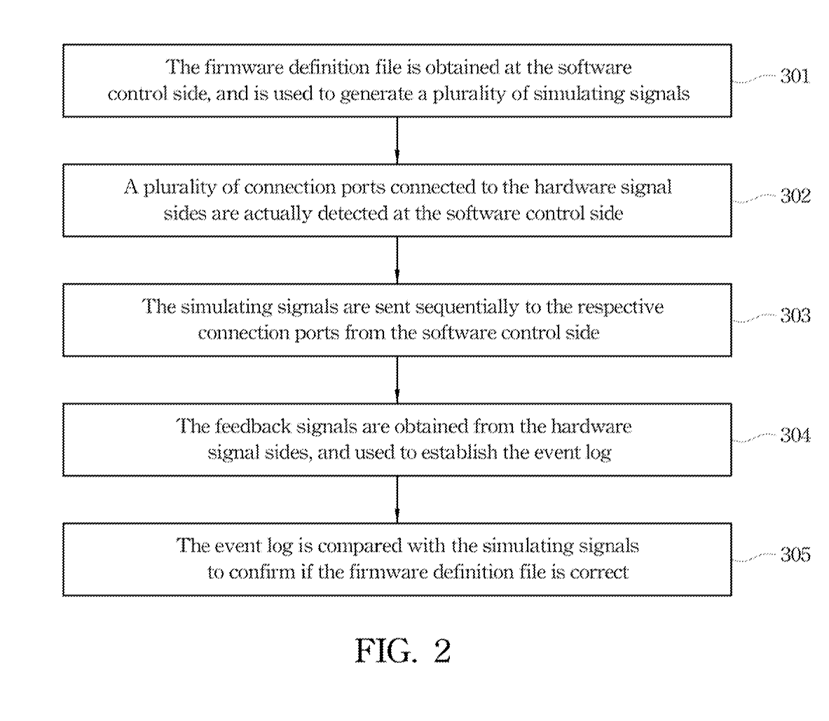

Referring to FIG. 2, FIG. 2 is a flow chart showing a method for checking a firmware definition file according to an embodiment of the present invention. In FIG. 2, the method of this embodiment includes the steps described in the below.

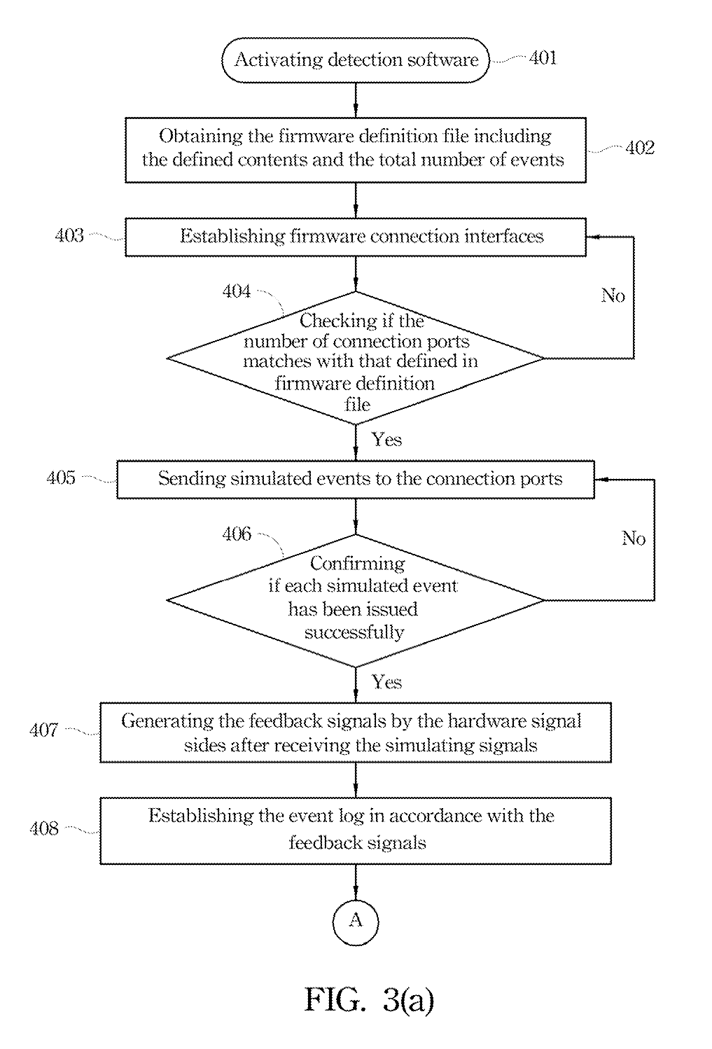

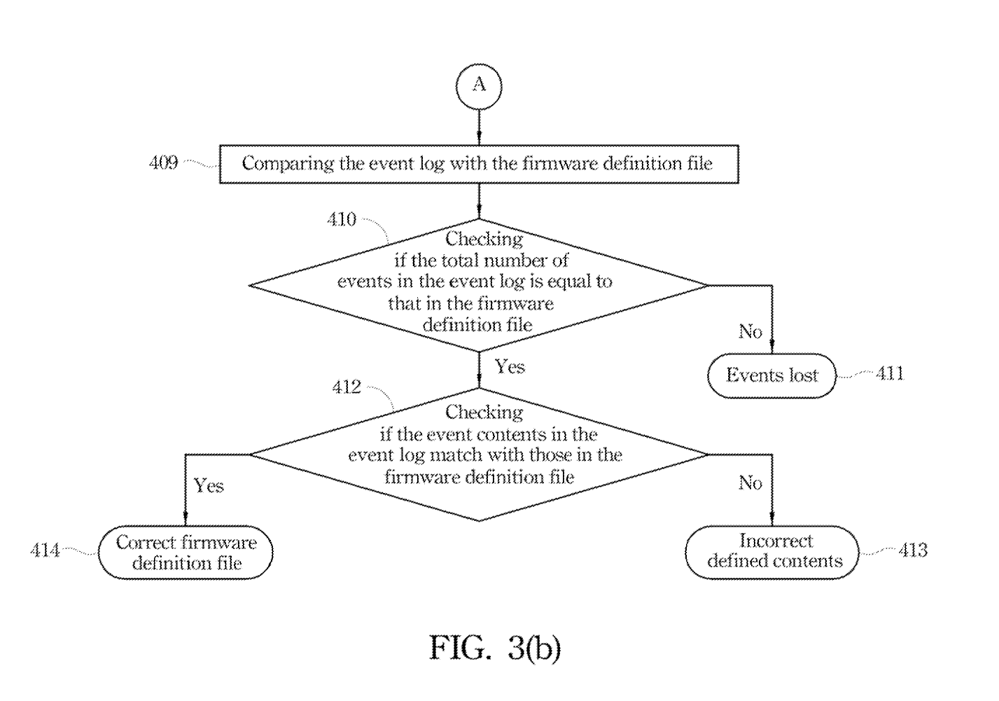

At first, in step 301, the firmware definition file is obtained at the software control side, and is used to generate a plurality of simulating signals. Then, in step 302, a plurality of connection ports connected to the hardware signal sides are actually detected at the software control side, thereby confirming if all of the hardware signal sides to be checked have been activated, thus preventing the situation of the hardware signal sides which are not activated from being considered as failed defined contents corresponding thereto. Thereafter, in step 303, the simulating signals are sent sequentially to the respective connection ports from the software control side, and further sent to the respective the hardware signal sides. Then, in step 304, the feedback signals is are obtained from the hardware signal sides, and used to establish the event log. Thereafter, in step 305, the event log is compared with the simulating signals so as to confirm if the firmware definition file is correct. It is noted that the comparison between the event log and the simulating signals can be used to check if a total number of events in the event log is equal to a defined number listed in the firmware definition file, and to check if an event content recorded in the event log matches with a defined content listed in the firmware definition file. Continuously referring to FIG. 3(a) and FIG. 3(b), FIG. 3(a) and FIG. 3(b) are a flow chart showing the detailed steps of FIG. 2. The detailed steps of the method for checking the firmware definition file are described as follows. At first, step 401 is performed to activate detection software. Then, step 402 is performed to obtain the firmware definition file including the defined contents and the total number of events. In other words, this embodiment uses the firmware definition file to generate a plurality of simulated events (signals) to check if the response of each hardware signal side matches with the contents defined in the firmware definition file.

Thereafter, step 403 is performed to establish firmware connection interfaces, i.e. the connection ports connecting to the hardware signal sides, thereby confirming if each of the hardware signal sides has been activated and remained at a status of waiting for checking. This step is used to exclude the detection results of unmatched comparisons caused by failing to activate the hardware signal sides. Then, step 404 is performed to check if the number of the connection ports matches with the number defined in the firmware definition file. If the number of the connection ports is correct, step 405 is performed to send various simulated events to the connection ports sequentially, and further is to the respective hardware signal sides to be checked. Thereafter, step 406 is performed to confirm if each simulated event has been sent successfully, thereby excluding the detection results of unmatched comparisons caused by failing to issue the event signals.

Then, in step 407, the hardware signal sides generate respective feedback signals after receiving the simulating signals. Thereafter, in step 408, the software control side establishes the event log in accordance with the feedback signals. Then, in step 409, the software control side compares the event log with the firmware definition file, and then step 410 is performed to check If the total number of events in the event log is equal to that in the firmware definition file. If the result of step 410 is no, it means that certain events are lost (step 411), i.e., the hardware signal sides corresponding the lost events fail to reflect the feedback signals based on the simulating signals. If the result of step 410 is yes, step 412 is performed to check if the event contents recorded in the event log match with those listed in the firmware definition file. If the result of step 412 is no, it means that the defined contents in the firmware definition file are incorrect (step 413), such as a situation of mistakenly considering an over-high temperature as a normal temperature. Thereafter, if the total numbers of events and the event contents in the event log match with those in the firmware definition file, it means that the firmware definition file is correct (step 414).

In view of the forgoing, the method of this embodiment can detect the errors of the firmware definition file systematically and strictly. In other words, the method of this embodiment can promote the control quality of a system to respective hardware sides, and reduce to time and manpower required for system development.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for checking a firmware definition file, comprising:
a software control side having the firmware definition file, wherein the software control side generates a plurality of simulating signals in accordance with the firmware definition file; and
a plurality of hardware signal sides receiving the simulating signals respectively so as to generate a plurality of feedback signals fed to the software control side;
wherein the software control side establishes an event log in accordance with the feedback signals, and uses the event log to check if the firmware definition file is correct.

2. The system as claimed in claim 1, wherein the hardware signal sides comprises a temperature sensor.

3. The system as claimed in claim 1, wherein the hardware signal sides comprises a clock sensor of an operation chip.

4. The system as claimed in claim 1, wherein the hardware signal sides comprises a fan speed sensor.

5. The system as claimed in claim 1, wherein the hardware signal sides comprises a voltage sensor.

6. The system as claimed in claim 1, wherein the hardware signal side is a current sensor.

7. A method for checking a firmware definition file, comprising:
reading the firmware definition file from a software control side, and
generating a plurality of simulating signals in accordance with the firmware definition file;
actually detecting a plurality of connection ports by the software control side, wherein the connection ports are corresponding to a plurality of hardware signal sides;
sending the simulating signals to the hardware signal sides from the software control side via the connection ports;
obtaining a plurality of feedback signals from the hardware signal sides, establishing an event log by using the feedback signals; and
comparing the event log with the feedback signals for checking the firmware definition file.

8. The method as claimed in claim 7, wherein the step of comparing the event log with the feedback signals for checking the firmware definition file further comprises:
checking if a total number of events in the event log is equal to a defined number listed in the firmware definition file.

9. The method as claimed in claim 7, wherein the step of comparing the event log with the feedback signals for checking the firmware definition file further comprises:
checking if an event content recorded in the event log matches with a defined content listed in the firmware definition file.

10. A method for checking a firmware definition file, comprising:
reading the firmware definition file from a software control side;
actually detecting a plurality of connection ports by the software control side, wherein the connection ports are corresponding to a plurality of hardware signal sides;
checking if the number of the connection ports matches with a number defined in the firmware definition file;
sequentially sending a plurality of simulating signals to the hardware signal sides from the software control side via the connection ports when the number of the connection ports matches with the number defined in the firmware definition file;
confirm if the simulated signals have been sent successfully;
obtaining a plurality of feedback signals from the hardware signal sides when the simulated signals have been sent successfully;
establishing an event log by using the feedback signals;
comparing the event log with the feedback signals for checking the firmware definition file;
checking if a total number of events in the event log is equal to a defined number listed in the firmware definition file; and
checking if an event content recorded in the event log matches with a defined content listed in the firmware definition file when the total number of events in the event log is equal to the defined number listed in the firmware definition file, wherein the firmware definition file is correct when the event content recorded in the event log matches with the defined content listed in the firmware definition file.
